(19) United States
(12) Patent Application Publication
(10) Pub. No.: US 2006/0107331 A1
(43) Pub. Date: May 18, 2006

(54) Objective management apparatus, medium, and method with group organization

(75) Inventors: Hong-sig Kim, Seongnam-si (KR); Jae-chan Park, Yongin-si (KR); Youn-ho Kim, Hwaseong-si (KR); Jin-sang Whang, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/272,140

(22) Filed: Nov. 14, 2005

(30) Foreign Application Priority Data
Nov. 13, 2004 (KR) 10-2004-0092806

(51) Int. Cl. H04N 7/16; H04L 9/32; G06F 17/30; G06F 7/04; G06K 9/00; H03M 1/68; H04K 1/00; H04L 9/00

(52) U.S. Cl. 726/26

(57) ABSTRACT

An objective management apparatus, medium, and method with group organization that can efficiently manage a degree of objective achievement by effectively organizing a group and giving rise to competition among group members of a group or among groups. The objective management apparatus may include a plurality of communication terminals receiving objective data including personal objectives of a plurality of users and actual result data which are results of the users' execution for achieving the personal objectives, and an objective management server connected to the plurality of communication terminals through a network and supplied with the objective data and the actual result data. Here, the objective management server may further include a group database storing a plurality of groups organized by group objectives in a database, a group designating unit designating each of the users to the group having a group objective most similar to their personal objectives, a personal objective-achievement checking unit checking whether the actual result data of each member in the group reach the group objective, and an actual result providing unit providing all the communication terminals with the actual result data of all the group members.

### CROSS-REFERENCE TO RELATED APPLICATIONS

This application claims the priority benefit of Korean Patent Application No. 10-2004-0092806, filed on Nov. 13, 2004, in the Korean Intellectual Property Office, the disclosure of which is incorporated herein in its entirety by reference.

### BACKGROUND OF THE INVENTION

1. Field of the Invention

Embodiments of the present invention relate to management of objectives, and more particularly to an objective management apparatus, medium, and method with group organization which can efficiently manage the degree of achievement of one's objective, i.e., goal, by organizing a group and generating competition among group members of a group or among groups.

2. Description of the Related Art

FIG. 1 is a flowchart illustrating a conventional objective management method. Referring to FIG. 1, a user registered in an objective management server can register his desired objective, i.e., desired goals, in operation 110.

Then, a user can input management data, as values of his objective, to the objective management server at predetermined intervals, i.e., at a predetermined time, in operation 120. The objective management server can then check whether the input management data corresponds to the user having met the registered objectives, in operation 130, i.e., has the desired goal been met based on the input data.

When the objective management server determines that the management data corresponds to the user having met the registered objective, the objective management server can give a predetermined reward to the users, in operation 140.

When the objective management server determines that the management data is not sufficient for the user to have met the registered objective, the objective management server can calculate the percentage or amount the management data differs from the objective, in operation 150, and notifies the user of the calculated offset, in operation 160.

Thus, such an objective management method independently manages the degree of objective achievement for each user. Accordingly, a user desiring to achieve an objective, using the conventional objective management method, can achieve the objective through only the users own determination, i.e., without any outside encouragement. Thus, the objective management server cannot press the user or provide additional encouragement for achieving the objective.

That is, the conventional objective management method is not helpful when a user gets tired of achieving the objective and loses his will or desire to achieve the objective. In order to solve this problem, there has been suggested a method of providing such encouragement through a game, while still using the conventional objective management method. However, the aforementioned loss of drive or desire problems still are not solved when a user is not continuously interested in the game. Accordingly, a better technique is needed.

### SUMMARY OF THE INVENTION

Embodiments of the present invention sets forth an objective management system, medium, and method with group organization that can efficiently manage the degree of objective achievement by effectively organizing a group and generating competition among group members of a group or among groups.

To achieve the above and/or other aspects and advantages, embodiments of the present invention include an objective management system, including a plurality of communication terminals to receive respective objective data including personal objectives of a plurality of users and actual result data, which are results of respective users' execution for achieving respective personal objectives, and an objective management system to connect with the plurality of communication terminals through a network, to receive objective data and/or the actual result data from a communication terminal, wherein the objective management system includes a group database to store a plurality of groups, organized by group objectives, a group designating unit to designate users to corresponding groups having group objectives similar to each user's personal objectives, and a personal objective-achievement checking unit to determine whether an actual result data of a group member of a group has reached a corresponding group objective.

The system may further include an actual result providing unit to provide all corresponding communication terminals with actual result data received from the corresponding communication terminals. The actual result providing unit may provide the actual result data to all the corresponding communication terminals based on a request from one of the communication terminals.

The personal objective-achievement checking unit may further determine whether actual result data of each group member of the group has reached a corresponding group objective to determine whether the corresponding group objective has been achieved. Groups may be stored in the group database are updatable.

In addition, the personal objective-achievement checking unit may calculate a ratio of actual result data of each group member of the group to the corresponding group objective.

Further, information of one or more assistants helping the group or members of the group to achieve the corresponding group objective may be stored in the group database based upon roles of respective assistants, wherein the group designating unit designates each user to a group having a corresponding group objective similar to respective personal objectives of respective users and generates an assistant group included in the designated group by matching the respective users with an assistant, and wherein the actual result providing unit provides communication terminals used by assistants belonging to the assistant group with honesty data of the assistants, with the honesty data being a degree that a respective assistant played a role in achieving the corresponding group objective of the designated group.

The corresponding group objective may be to reduce weight by a predetermined ratio within a predetermined period of time.

To achieve the above and/or other aspects and advantages, embodiments of the present invention include an objective management system, including a group database to store a plurality of groups, organized by respective group objectives, a group designating unit to designate users to a respective group having a respective group objective similar to respective personal objectives provided by each user, and a personal objective-achievement checking unit to determine whether actual result data provided by group members of a group reach a group objective, wherein the actual result data are corresponding results of each respective users' execution toward achieving a respective personal objective.

To achieve the above and/or other aspects and advantages, embodiments of the present invention include an objective management system, including a plurality of communication terminals to receive respective objective data including personal objectives of a plurality of respective users and/or actual result data, which are respective results of respective users' execution toward achieving respective personal objectives, and an objective management system to connect with the plurality of communication terminals, through a network, and to receive objective data and/or the actual result data, wherein the objective management system includes a group database storing a plurality of groups, organized by group objectives, a group designating unit to designate users to corresponding groups having group objectives similar to each user's personal objective, a group matching unit to match groups having similar group objectives and organizing a set of competitive groups based on the matched groups, a group objective-achievement checking unit to check whether a group exists in the set of competitive groups where actual result data of corresponding group members reach a corresponding group objective.

The group objective-achievement checking unit may check whether all group members of the group reach the corresponding group objective. In addition, the system may further include an actual result providing unit to provide all communication terminals of the set of competitive groups with corresponding actual result data of all corresponding group members.

Information about one or more assistants helping the group or members of the group to achieve the corresponding group objective may be stored in the group database based upon roles of respective assistants, wherein the group designating unit designates each user to a group having a corresponding group objective similar to respective personal objectives of respective users and generates an assistant group included in the designated group by matching respective users with an assistant, and wherein the actual result providing unit provides communication terminals used by assistants belonging to the assistant group with honesty data of the assistants, with the honesty data being a degree that a respective assistant played a role in achieving the corresponding group objective of the designated group.

To achieve the above and/or other aspects and advantages, embodiments of the present invention include an objective management system, with group organization, including a group database storing a plurality of groups organized by group objectives, a group designating unit to designate each of a plurality of users to groups having corresponding group objectives similar to respective personal objectives of respective users, a group matching unit to match groups having similar group objectives and organizing a set of competitive groups based on the matched groups, and a group objective-achievement checking unit to check whether a group exists in the set of competitive groups where actual result data of group members reach a corresponding group objective, wherein the actual result data are corresponding results of each respective users' execution toward achieving respective personal objectives.

The system may include an actual result providing unit to provide provided actual result data to communication terminals of the set of competitive groups. The method may further include an actual result providing unit to provide provided actual result data to communication terminals of the set of competitive groups upon request from a member of a group of the set of competitive groups.

In addition, the group objective-achievement checking unit may calculate a ratio of actual result data of each member of the set of competitive groups to the corresponding group objective.

To achieve the above and/or other aspects and advantages, embodiments of the present invention include an objective management method with group organization, the method including receiving personal objectives of a plurality of users and automatically designating each user to respective groups, having respective group objectives similar to respective personal objectives, among a plurality of groups organized by respective objectives, receiving actual result data, which are respective user achievement results of respective personal objectives, automatically checking whether corresponding received actual result data reaches a group objective of a group, to generate competition within the group.

The method may further include repeating the receiving of the actual result data when none of the corresponding received actual result data reaches the group objective. In addition, the designating of each user to a respective group may include generating groups corresponding to corresponding personal objectives of users, and designating a user to at least one of the generated groups.

To achieve the above and/or other aspects and advantages, embodiments of the present invention include an objective management method with group organization, the method including receiving personal objectives of a plurality of users and automatically designating each user to respective groups, having respective group objectives similar to respective personal objectives, among a plurality of groups organized by respective objectives, generating a set of competitive groups by matching groups having similar group objectives, receiving actual result data, which are respective user achievement results of respective personal objective, automatically checking whether any group exists, in the set of competitive groups, in which corresponding received actual result data, of corresponding group members, reach corresponding group objectives.

The method may further include repeating the receiving of the actual result data when no group exists in which the corresponding received actual result data reach the corresponding group objectives.

To achieve the above and/or other aspects and advantages, embodiments of the present invention include a medium including computer readable code to implement an objective management method, with group organization, the method including receiving personal objectives of a plurality of users and automatically designating each user to respective groups, having respective group objectives similar to respective personal objectives, among a plurality of groups organized by respective objectives, receiving actual result data, which are respective user achievement results of respective personal objectives, automatically checking whether corresponding received actual result data reaches a group objective of a group, to generate competition within the group.

To achieve the above and/or other aspects and advantages, embodiments of the present invention include a medium including computer readable code for an objective management method, with group organization, the method including receiving personal objectives of a plurality of users and automatically designating each user to respective groups, having respective group objectives similar to respective personal objectives, among a plurality of groups organized by respective objectives, generating a set of competitive groups by matching groups having similar group objectives, receiving actual result data, which are respective user achievement results of respective personal objective, automatically checking whether any group exists, in the set of competitive groups, in which corresponding received actual result data, of corresponding group members, reach corresponding group objectives.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart illustrating a conventional objective management method;

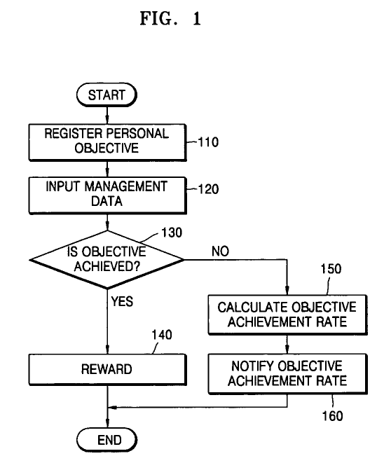

FIG. 2 illustrates an objective management system with group organization, according to an embodiment of the present invention;

FIG. 3 illustrates an objective management system with group organization, such as in the arrangement of FIG. 2, according to an embodiment of the present invention;

FIG. 4 is a flowchart illustrating an objective management method with group organization, according to an embodiment of the present invention;

FIG. 5 is a flowchart illustrating in detail an operation, such as operation 422 shown in FIG. 4, according to an embodiment of the present invention; and

FIG. 6 is a table illustrating an example to which an embodiment of the present invention has been specifically applied.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

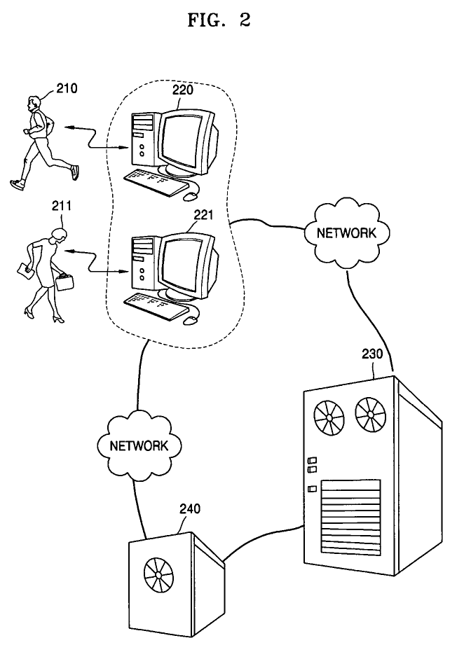

FIG. 2 illustrates an objective management apparatus with group organization, according to an embodiment of the present invention. As shown in FIG. 2, a plurality of communication terminals 220 and 221 can be connected to an objective management server 230 and a reward server 240, for example. Here, the objective management server 230 can be connected to the reward server 240.

Here, the users 210 and 211 can further input objective data, including their personal objectives, for example, to the communication terminals 220 and 221. The input objective data may then be transmitted to the objective management server 230.

The objective management server 230 may store a plurality of groups, organized by group objectives, for example. The objective management server 230 may designate the users 210 and 211 to the groups having group objectives most similar to the transmitted personal objectives, as a further example.

The respective users 210 and 211, who may have been designated to the respective groups, may input actual result data, which may be results of their respective execution or achievements, e.g., for achieving their personal objectives, to the communication terminals 220 and 221. The input actual result data may then be transmitted to the objective management server 230.

The objective management server 230 may determine whether the actual result data achieves either of the users group objectives. When it is determined that the actual result data achieves the group objectives, the objective management server 230 can notify the reward server 240 of the achievement of the group objective, and the reward server 240 may inform the communication terminals 220 and 221 of the fact that a reward will be given later to the respective users having achieved their group objective.

Referring to FIG. 2, the objective management server 230 may receive the objective data and the actual result data through the communication terminals 220 and 221, for example, noting that this delivery method is intended only for the purpose of conveniently explaining an embodiment of the present invention, i.e., the objective data and the actual result data may be input directly from the users, or through other avenues.

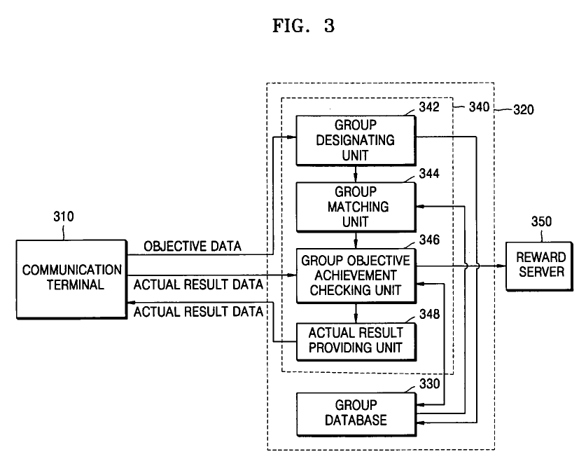

FIG. 3 is a block diagram illustrating, in detail, a structure such as that of FIG. 2, according to an embodiment of the present invention. Thus a structure of FIG. 2 will be described in greater detail now with reference to FIG. 3. Referring to FIG. 3, the objective management system, with group organization may include one or more communication terminals 310, an objective management server 320, and a reward server 350, for example.

The communication terminal 310 may receive objective data and actual result data from a plurality of users. The objective data can be data including personal objectives of the users and may be input by all the users, for example. The actual result data may be result data of each user's execution for achieving their personal objectives and may be input, for example, by users belonging to a specific group at predetermined intervals, e.g., according to a predetermined time period, noting that embodiments of the present invention are not limited thereto.

The indicated personal objective corresponds to an objective desired to be achieved by each user. For example, in the case where a user wants to reduce their weight by 10 Kg, the personal objective of the user may be “reduction in weight by 10 Kg”.

The number of communication terminals 310 preferably may correspond to the number of users. However, embodiments of the present invention are not limited to this case. That is, a plurality of users may input their objective data and the actual result data to one communication terminal, or alternate terminals, for example.

The objective management server 320 may include a group database 330 and a control unit 340, for example.

The group database 330 may store a plurality of groups organized by group objectives. The stored groups in the group database 330 may not be stored as group members yet, but embodiments of the present invention are not limited to this case.

The group objective corresponds to an objective desired by each group. For example, in a case where a number of users each desire to reduce their weight by 10%, these users make up a group, and the group objective could be the “reduction in weight by 10%”. Since corresponding actual result data would, preferably, be results evidencing achievement of the personal objectives, with the actual result data being values of weights individually input by the users designated to the group.

On the other hand, the group objective may include only one objective or a plurality of objectives. That is, the group objective may include only one objective such as “reduction in weight by 10%”, or may include a plurality of objectives such as “reduction in weight by 10% and entry of blood pressure into a normal range”.

In addition, it may be preferable that the group objective includes a target period of time and a target value. For example, the group objective of “reduction in weight by 10% from May 1 to Jul. 31” includes a target period of time of “three months from May 1 to Jul. 31” and a target value of “reduction in weight by 10%”.

A plurality of groups having the same group objective may exist among the groups stored in the group database 330, for example.

The control unit 340 may designate the respective users to specific groups and monitor whether the actual result data input by the respective users, designated to the specific groups, reach the group objective.

The control unit 340 may include a group designating unit 342, a group matching unit 344, a group objective-achievement checking unit 346, and an actual result providing unit 348. The group matching unit 344 may only be used as needed, and in this case, the group objective-achievement checking unit 346 may be replaced with a personal objective-achievement checking unit.

The group designating unit 342 receives the objective data and recognizes the personal objective included in the objective data. The group designating unit 342 may search the group database 330 for a group having a group objective most similar to the recognized personal objective.

When the group having the aforementioned group objective is found in the group database 330, the group designating unit 342 may designate the user, having input the objective data, to the found group.

For example, when a user A with weight of 60 Kg has a personal objective of “reduction in weight by 10%” and a group A having a group objective of “reduction in weight by 10%” exists in the group database 330, the group designating unit 342 may designate the user A to the group A. If the group objective of “reduction in weight by 10%” does not exist in the group database 330 and only group objectives of “reduction in weight by 11%” and “reduction in weight by 8%” exist in the group database 330, the group designating unit 342 may selectively designate the user A to the group having the group objective of “reduction in weight by 11%”, for example, as it may be the closest group

The group designating unit 342 may further include a first group generating unit (not shown). The first group generating unit can generate a group having a group objective equal to a personal objective. The first group generating unit may transmit the generated group to the group database 330, and the transmitted group may then be stored in the group database 330.

As a result, when the group having the group objective is not found in the group database 330, the first group generating unit of the group designating unit 342 can generate a group having the group objective. Thereafter, the group designating unit 342 can designate the user having input the objective data to the generated group.

Further, each user may employ assistants for helping each user with the achievement of his personal objective. For example, in a case where the user A wants to reduce his weight by 6 Kg, the user A can employ, as assistants, dietitians for helping the user A with achieving the personal objective of “reduction in weight by 6 Kg”.

For this purpose, the group designating unit 342 may further include a second group generating unit (not shown) and a role designating unit (not shown). The second group generating unit may generate an assistant group, including one or more assistants for helping a user to achieve the respective user's personal objective or group objective. The role designating unit may designate the assistants to the roles for helping in the achievement of the personal objectives. Information on the assistant group generated by the second group generating unit and the roles of the assistants may preferably be stored in the group database 330.

For example, when the user A, belonging to the group A having the group objective of “reduction in weight by 10%”, is the head of his family, the user A may employ family members as assistants for helping the user A to achieve his personal objective. In this case, the second group generating unit may generate an assistant group A, having the family members of the user A, as group members. For example, when the assistant group includes the wife and the son of the user A, the role designating unit may designate the roles of the wife and the son. The role designating unit may, for example, designate “to take a walk with the user A one or more times per week” as the role for the wife and “to execute sit-ups with the user A every night” as the role for the son. The roles may be designated in advance or designated by the user A, noting that additional embodiments are equally available.

The group matching unit 344 may select one or more groups having similar group objectives, with the similarity being within a predetermined range, and with the one or more groups being selected from a plurality of groups managed by the group designating unit 342, and may accordingly generate a set of competitive groups. For example, it may be assumed that a group A has a group objective of “reduction in weight by 10% from May 1 to Jul. 31”, a group B has a group objective of “reduction in weight by 12% from Aug. 1 to Oct. 31”, and both groups are stored in the group database 330. In this case, the group matching unit 344 may search the group database 330 to select a group to compete with the group A, and may then select the group B. As a result, the group A and the group B can make up a set of competitive groups and compete with each other to achieve the group objectives for the shorter time.

The number of groups belonging to a set of competitive groups is not limited to two, but may be increased as desired. It may be most desirable, for example, that group objectives of the groups belonging to a set of competitive groups are equivalent to one another, though this is not necessary.

The checking unit 346 may receive the actual result data, e.g., from all the group members belonging to a set of competitive groups, e.g., according to predetermined intervals. In the above case, of the set of competitive groups including groups A and B, weights measured by the respective group members may be taken every weekend and forwarded as the actual result data, for example.

The input of the actual result data may be carried out by any transmission device with the input actual result data for transmission to the communication terminal 310, or may be carried out directly by entry to the checking unit 346. In the case of the above group A, the communication terminal 310 may preferably have a function of a body weight scale, for example, with the communication terminal 310 receiving and transmitting the actual result data to the checking unit 346.

The group objective-achievement checking unit 346, receiving the actual result data can determine which, if any, group has provided actual result data for all the corresponding group members that reach the corresponding group objective, among the groups belonging to the set of competitive groups, from the group database 330, for example.

When the group objective-achievement checking unit 346 determines that one or more of the groups' actual result data indicate that the groups have achieved their group objectives, the group objective-achievement checking unit 346 may notify the reward server 350 of the same.

The actual result providing unit 348 may provide all the communication terminals of the respective set of competitive groups with the actual result data of all the corresponding members, or an averaging of the result data of each group, for example. The averaged result data for each group may be average values of all the actual result data of each group, as a further example. The actual result providing unit 348 may continuously separately operate or operate only upon request from a communication terminal used by a group member to the objective management server 320.

If a member belongs to an assistant group, the actual result providing unit 348 may also provide all the communication terminals used by assistants belonging to the assistant group with honesty data of all the assistants, with the honesty data indicating the degree to which the assistants performed their role in achieving the group objective.

However, in an embodiment where the group matching unit 344 is omitted, competition among groups may not be carried out, but competition among group members may still be carried out, for example. In this case, the group objective-achievement checking unit 346 may be referred to as a personal objective-achievement checking unit, and the personal objective-achievement checking unit may determine whether actual result data of the users belonging to the group have reached their group objective. In this case, the actual result providing unit 348 may provide all the group members with the actual result data of all the group members, for example.

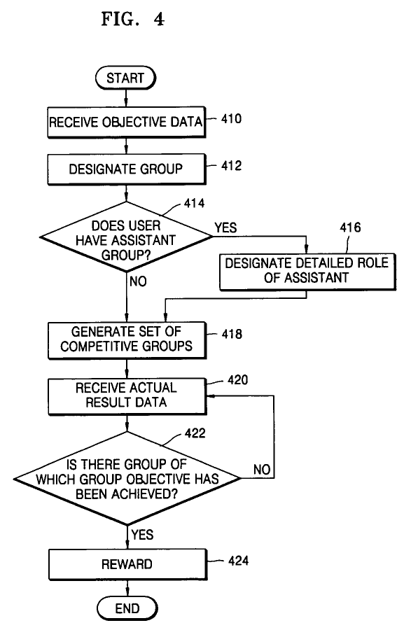

FIG. 4 is a flowchart illustrating an objective management method with group organization, according to an embodiment of the present invention. The objective management method illustrated in FIG. 4 will also be described with reference to the above objective management system embodiment of FIG. 3.

Referring to the FIGS. 3 and 4, the group designating unit 342 of the objective management server 320 may receive objective data from a communication terminal used by a user, e.g., in operation 410.

The group designating unit 342 may designate a user to a specific group based on the desired objective of the user, e.g., in operation 412. The group designating unit 342, of the objective management server 320, may check whether the user has an assistant group, e.g., in operation 414. When the user does not have an assistant group, the group matching unit 344 may generate a set of competitive groups, e.g., in operation 418.

When the user does have an assistant group, the group designating unit 342 may designate detailed roles to assistants, e.g., in operation 416, and then the group matching unit 344 may select a group competing with the group to which the user belongs and generate a set of competitive groups, e.g., in operation 418.

The group objective-achievement checking unit 346, of the objective management server 320, may receive actual result data from the communication terminal used by a user at predetermined intervals, e.g., in operation 420, and then may determine whether all the members of any of the groups have achieved their group objective, e.g., in operation 422. The predetermined time intervals may preferably always be the same.

As a result of the determining operation, when there exist one or more groups whose members have all achieved the group objective, this operation may be ended. In this case, the reward server 350 may then subsequently notify all the communication terminals used by members of the group for which their group objective has been achieved of a reward, e.g., in operation 424.

Conversely, as a result of the determination operation, when no group has achieved their group objective, the group objective-achievement checking unit 346 may again receive subsequent actual result data after a predetermined period of time has lapsed, e.g., in operation 420, and then may again determine whether any of the groups' objective has been achieved, e.g., in operation 422. In this way, the group objective-achievement checking unit 346 may continuously receive actual result data at predetermined intervals until at least one of the groups achieves their respective objective.

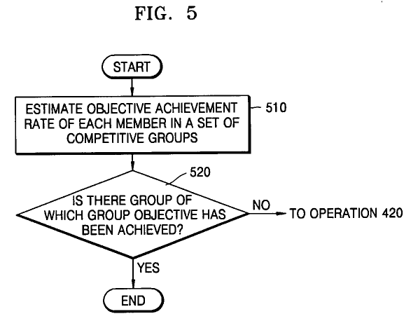

FIG. 5 is a flowchart illustrating an operation such as operation 422 of FIG. 4. As shown in FIG. 5, a group objective-achievement checking unit 346 may calculate rates at which actual result data of each group member reach the group objective, e.g., in operation 510. Thereafter, the group objective-achievement checking unit 346 may determine whether there is a group, of all the groups belonging to a competitive group, whose group members have all achieved their group objective, e.g., in operation 520. When the group objective-achievement checking unit 346 determines that there is no group whose group objective has been achieved, operation 420 of FIG. 4, for example, may then again be performed.

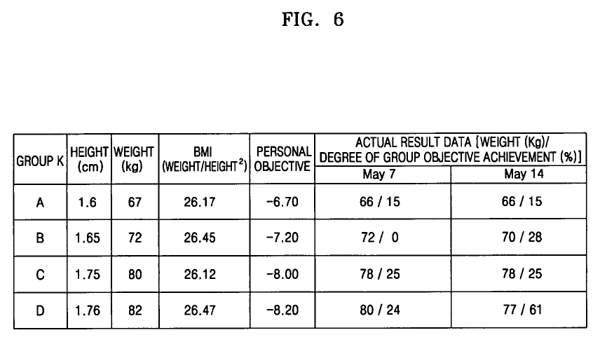

FIG. 6 is a table illustrating an example to which an embodiment of the present invention has been specifically applied, e.g., an example to which the embodiment of FIG. 3 is specifically applied. Referring to FIG. 6, users A, B, C, and D may make up a group K. Such a group K may have previously been stored in the group database 330, or may be newly generated by the group designating unit, of the objective management server 320, and then stored in the group database 330, for example.

For example, here, it may be assumed that the users A, B, C, and D want to reduce their weights by 6.7 KG, 7.2 Kg, 8 Kg, and 8.2 Kg, respectively, for three months.

More specifically, the personal objective of the user D may be to reduce his weight by 8.2 Kg and the group objective of the group K may be “to reduce weight by 10% from May 1 to Jul. 31”.

The members of the group K may reside in Bundang-ku, of Seongnam, for example, and may each be 21 years old. That is, predetermined conditions may be required to organize a group and such conditions may be included in the group objective, though embodiments of the present invention are not limited thereto.

The group objective-achievement checking unit 346 may receive actual result data, that is, weights, from the users on May 7 and May 14, for example. In this case, the rate at which the group objective is achieved may be obtained by subtracting the current weight from the initial weight, dividing the subtracted result by the personal objective value, and then multiplying the divided result by 100. For example, the objective achievement rate of the user A on May 7 may be ((67−66)/6.7)×100=15%.

In addition to the above described embodiments, embodiments of the present invention can also be implemented through computer readable code/instructions in/on a medium, e.g., a computer readable medium. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example, noting that such examples are not limited thereto. The media may also be a distributed network, so that the computer readable code is stored/transferred and implemented in a distributed fashion.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An objective management system, comprising:
a plurality of communication terminals to receive respective objective data including personal objectives of a plurality of users and actual result data, which are results of respective users' execution for achieving respective personal objectives; and
an objective management system to connect with the plurality of communication terminals through a network, to receive objective data and/or the actual result data from a communication terminal,
wherein the objective management system comprises:
a group database to store a plurality of groups, organized by group objectives;
a group designating unit to designate users to corresponding groups having group objectives similar to each user's personal objectives; and
a personal objective-achievement checking unit to determine whether an actual result data of a group member of a group has reached a corresponding group objective.

2. The objective management system of claim 1, further comprising:
an actual result providing unit to provide all corresponding communication terminals with actual result data received from the corresponding communication terminals.

3. The objective management system of claim 2, wherein the actual result providing unit provides the actual result data to all the corresponding communication terminals based on a request from one of the communication terminals.

4. The objective management system of claim 1, wherein the personal objective-achievement checking unit further determines whether actual result data of each group member of the group has reached a corresponding group objective to determine whether the corresponding group objective has been achieved.

5. The objective management system of claim 1, wherein groups stored in the group database are updatable.

6. The objective management system of claim 1, wherein the personal objective-achievement checking unit calculates a ratio of actual result data of each group member of the group to the corresponding group objective.

7. The objective management system of claim 1, wherein information of one or more assistants helping the group or members of the group to achieve the corresponding group objective is stored in the group database based upon roles of respective assistants,
wherein the group designating unit designates each user to a group having a corresponding group objective similar to respective personal objectives of respective users and generates an assistant group included in the designated group by matching the respective users with an assistant, and
wherein the actual result providing unit provides communication terminals used by assistants belonging to the assistant group with honesty data of the assistants, with the honesty data being a degree that a respective assistant played a role in achieving the corresponding group objective of the designated group.

8. The objective management system of claim 1, wherein the corresponding group objective is to reduce weight by a predetermined ratio within a predetermined period of time.

9. An objective management system, comprising:
a group database to store a plurality of groups, organized by respective group objectives;
a group designating unit to designate users to a respective group having a respective group objective similar to respective personal objectives provided by each user; and
a personal objective-achievement checking unit to determine whether actual result data provided by group members of a group reach a group objective,
wherein the actual result data are corresponding results of each respective users' execution toward achieving a respective personal objective.

10. The objective management system of claim 9, wherein the personal objective-achievement checking unit determines whether actual result data provided by all group members of the group reach the group objective.

11. The objective management system of claim 9, wherein groups stored in the group database are updatable.

12. The objective management system of claim 9, further comprising an actual result providing unit to provide provided actual result data to communication terminals of the group.

13. The objective management system of claim 9, wherein the personal objective-achievement checking unit calculates a ratio of actual result data of each group member of the group to the group objective.

14. The objective management system of claim 9, wherein the group objective is to reduce weight by a predetermined ratio within a predetermined period of time.

15. An objective management system, comprising:
a plurality of communication terminals to receive respective objective data including personal objectives of a plurality of respective users and/or actual result data, which are respective results of respective users' execution toward achieving respective personal objectives; and
an objective management system to connect with the plurality of communication terminals, through a network, and to receive objective data and/or the actual result data,
wherein the objective management system comprises:
a group database storing a plurality of groups, organized by group objectives;
a group designating unit to designate users to corresponding groups having group objectives similar to each user's personal objective;
a group matching unit to match groups having similar group objectives and organizing a set of competitive groups based on the matched groups;
a group objective-achievement checking unit to check whether a group exists in the set of competitive groups where actual result data of corresponding group members reach a corresponding group objective.

16. The objective management system of claim 15, wherein the group objective-achievement checking unit checks whether all group members of the group reach the corresponding group objective.

17. The objective management system of claim 15, further comprising an actual result providing unit to provide all communication terminals of the set of competitive groups with corresponding actual result data of all corresponding group members.

18. The objective management system of claim 15, wherein groups stored in the group database are updatable.

19. The objective management system of claim 15, wherein information about one or more assistants helping the group or members of the group to achieve the corresponding group objective is stored in the group database based upon roles of respective assistants,
wherein the group designating unit designates each user to a group having a corresponding group objective similar to respective personal objectives of respective users and generates an assistant group included in the designated group by matching respective users with an assistant, and
wherein the actual result providing unit provides communication terminals used by assistants belonging to the assistant group with honesty data of the assistants, with the honesty data being a degree that a respective assistant played a role in achieving the corresponding group objective of the designated group.

20. The objective management system of claim 15, wherein the group objective-achievement checking unit calculates a ratio of actual result data of each member of the set of competitive groups to the corresponding group objective.

21. The objective management system of claim 15, wherein the corresponding group objective is to reduce weight by a predetermined ratio within a predetermined period of time.

22. An objective management system, with group organization, comprising:
a group database storing a plurality of groups organized by group objectives;
a group designating unit to designate each of a plurality of users to groups having corresponding group objectives similar to respective personal objectives of respective users;
a group matching unit to match groups having similar group objectives and organizing a set of competitive groups based on the matched groups; and
a group objective-achievement checking unit to check whether a group exists in the set of competitive groups where actual result data of group members reach a corresponding group objective,
wherein the actual result data are corresponding results of each respective users' execution toward achieving respective personal objectives.

23. The objective management system of claim 22, further comprising an actual result providing unit to provide provided actual result data to communication terminals of the set of competitive groups.

24. The objective management system of claim 22, further comprising an actual result providing unit to provide provided actual result data to communication terminals of the set of competitive groups upon request from a member of a group of the set of competitive groups.

25. The objective management system of claims 22, wherein groups stored in the group database are updatable.

26. The objective management system of claim 22, wherein the group objective-achievement checking unit calculates a ratio of actual result data of each member of the set of competitive groups to the corresponding group objective.

27. The objective management system of claim 22, wherein the corresponding group objective is to reduce weight by a predetermined ratio within a predetermined period of time.

28. An objective management method with group organization, the method comprising:
receiving personal objectives of a plurality of users and automatically designating each user to respective groups, having respective group objectives similar to respective personal objectives, among a plurality of groups organized by respective objectives;
receiving actual result data, which are respective user achievement results of respective personal objectives;
automatically checking whether corresponding received actual result data reaches a group objective of a group, to generate competition within the group.

29. The objective management method of claim 28, further comprising repeating the receiving of the actual result data when none of the corresponding received actual result data reaches the group objective.

30. The objective management method of claim 28, wherein the designating of each user to a respective group comprises:
generating groups corresponding to corresponding personal objectives of users; and
designating a user to at least one of the generated groups.

31. An objective management method with group organization, the method comprising:
receiving personal objectives of a plurality of users and automatically designating each user to respective groups, having respective group objectives similar to respective personal objectives, among a plurality of groups organized by respective objectives;
generating a set of competitive groups by matching groups having similar group objectives;
receiving actual result data, which are respective user achievement results of respective personal objective;
automatically checking whether any group exists, in the set of competitive groups, in which corresponding received actual result data, of corresponding group members, reach corresponding group objectives.

32. The objective management method of claim 31, further comprising repeating the receiving of the actual result data when no group exists in which the corresponding received actual result data reach the corresponding group objectives.

33. The objective management method of claim 31, wherein the designating of each user to a respective group comprises:
generating groups corresponding to corresponding personal objectives of users; and
designating a user to at least one of the generated groups.

34. A medium comprising computer readable code to implement an objective management method, with group organization, the method comprising:
receiving personal objectives of a plurality of users and automatically designating each user to respective groups, having respective group objectives similar to respective personal objectives, among a plurality of groups organized by respective objectives;
receiving actual result data, which are respective user achievement results of respective personal objectives;
automatically checking whether corresponding received actual result data reaches a group objective of a group, to generate competition within the group.

35. A medium comprising computer readable code for an objective management method, with group organization, the method comprising:
receiving personal objectives of a plurality of users and automatically designating each user to respective groups, having respective group objectives similar to respective personal objectives, among a plurality of groups organized by respective objectives;
generating a set of competitive groups by matching groups having similar group objectives;
receiving actual result data, which are respective user achievement results of respective personal objective;
automatically checking whether any group exists, in the set of competitive groups, in which corresponding received actual result data, of corresponding group members, reach corresponding group objectives.
